(19) United States
(12) Patent Application Publication
(10) Pub. No.: US 2023/0306984 A1
(43) Pub. Date: Sep. 28, 2023

(54) COMPUTER-READABLE RECORDING MEDIUM HAVING STORED THEREIN PROGRAM FOR GENERATING MODEL, INFORMATION PROCESSING APPARATUS, AND METHOD FOR GENERATING MODEL

(71) Applicant: Fujitsu Limited, Kawasaki-shi (JP)

(72) Inventor: Kousuke IEMURA, Kawasaki (JP)

(73) Assignee: Fujitsu Limited, Kawasaki-shi (JP)

(21) Appl. No.: 18/069,850

(22) Filed: Dec. 21, 2022

(30) Foreign Application Priority Data
Mar. 28, 2022 (JP) 2022-052280

(51) Int. Cl. G10L 21/057; G10L 21/0308

(52) U.S. Cl. CPC G10L 21/057; G10L 21/0308

(57) ABSTRACT

A computer-readable recording medium has stored therein a program for causing a computer to execute a process including: generating a voice processing model by executing machine learning using training data, the training data associating first training voice data obtained with a first microphone, second training voice data obtained with a second microphone different from the first microphone, and clarified training voice data with one another, the clarified training voice data being obtained by a clarifying process on voice contained at least one of the first training voice data and the second training voice data, the voice processing model generating clarified voice data in response to input of first inference voice data and second inference voice data.

### CROSS-REFERENCE TO RELATED APPLICATION

This application is based upon and claims the benefit of priority of the prior Japanese Patent application No. 2022-052280, filed on Mar. 28, 2022, the entire contents of which are incorporated herein by reference.

### FIELD

The embodiment discussed herein relates to a computer-readable recording medium having stored therein a program for generating a model, an information processing apparatus, and a method for generating a model.

### BACKGROUND

For example, a pin microphone is worn by every speaker and moves with the movement of the speaker wearing the microphone. In an environment in which such a microphone is worn by each of multiple speakers, a demand arises to extract only the voice of a particular speaker wearing a microphone.

However, the microphone may input not only the wearer's voice, but also the voice other than the wearer, and consequently may collect these voices. Inputting a voices of a person other than the wearer into the microphone like this is sometimes referred to as crosstalk.

One of the known methods to extract only a particular voice from multiple microphone voices is a technique that uses array microphones.

Another known method isolates individual voice signals by reducing crosstalk by updating a transmission function of crosstalk on multiple voices collected with multiple microphones.

Furthermore, still another known method converts a probability distribution of an observation vector at each frequency into a model on the basis of the observation vector of an observation signal recorded when the acoustic signals of the target sound source are mixed and isolates the sound source by estimating the masks of the acoustic signals.
[Patent Document 1] Japanese National Publication of International Patent Application No. 2008-507926
[Patent Document 2] International Publication Pamphlet No. WO2017/064840
[Patent Document 3] Japanese Laid-open Patent Publication No. 2018-40880

### SUMMARY

According to an aspect of the embodiment, a non-transitory computer-readable recording medium has stored therein a program for causing a computer to execute a process including: generating a voice processing model by executing machine learning using training data, the training data associating first training voice data obtained with a first microphone, second training voice data obtained with a second microphone different from the first microphone, and clarified training voice data with one another, the clarified training voice data being obtained by a clarifying process on voice contained at least one of the first training voice data and the second training voice data, the voice processing model generating clarified voice data in response to input of first inference voice data and second inference voice data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of a voice processing system according to an example of an embodiment;

FIG. 2 is a diagram illustrating an example of the functional configuration of the voice processing system according to an example of the one embodiment;

FIG. 3 is a diagram illustrating a method for generating an expanded recorded voice in the voice processing system according to an example of the one embodiment;

FIG. 4 is a diagram illustrating a method for selecting a clarified voice by a training data generating unit in the voice processing system according to an example of the one embodiment;

FIG. 5 is a diagram illustrating a crosstalk predicted voice generated by the training data generating unit in the voice processing system according to an example of the one embodiment;

FIG. 6 is a diagram illustrating a method for generating a training data by the training data generating unit in the voice processing system according to an example of the one embodiment;

FIG. 7 is a diagram illustrating a process in a training phase performed by a training processing unit in the voice processing system according to an example of the one embodiment;

FIG. 8 is a diagram illustrating input data in an inference phase of a machine learning model in the voice processing system according to an example of the one embodiment;

FIG. 9 is a diagram illustrating a process in the inference phase performed by an inference processing unit in the voice processing system according to an example of the one embodiment;

FIG. 10 is a flow diagram illustrating a process in the training phase in the voice processing system according to an example of the one embodiment;

FIG. 11 is a flow diagram illustrating a process in the inference phase in the voice processing system according to an example of the one embodiment; and

FIG. 12 is a diagram illustrating an inference result in the voice processing system according to an example of the one embodiment.

### DESCRIPTION OF EMBODIMENT(S)

However, the array microphones require respective fixed microphone positions and calibration performed in advance, and are unable to be used in an environment where both a speaker and a microphone position move. In other words, when a voice source moves, it is difficult to extract the voice at a high sound quality.

In addition, the method that updates the transmission function of crosstalk of multiple voice signals collected with multiple microphones and a method that isolates the sound source on the basis of an observation vector of an observation signal recorded when the acoustic signals of the target sound source are mixed do not assume that the sound source and a microphone move. Accordingly, when a voice source moves, it is difficult to extract the voice at a high sound quality.

Hereinafter, a computer-readable recording medium having stored therein a program for generating a model, a computer-readable recording medium having stored therein a program for processing voice, an information processing apparatus, a method for generating a model, and a method for processing a voice according to an embodiment of the present disclosure will now be described with reference to the drawings. However, the embodiment described below is merely illustrative and there is no intention to exclude the application of various modifications and techniques that are not explicitly described in the embodiment. In other words, the present embodiment can be variously modified and implemented (e.g., combining embodiments and modifications in any combination) without departing from the scope thereof. The drawings include not only appearing elements but also other functions not appearing therein.

<A> Configuration:

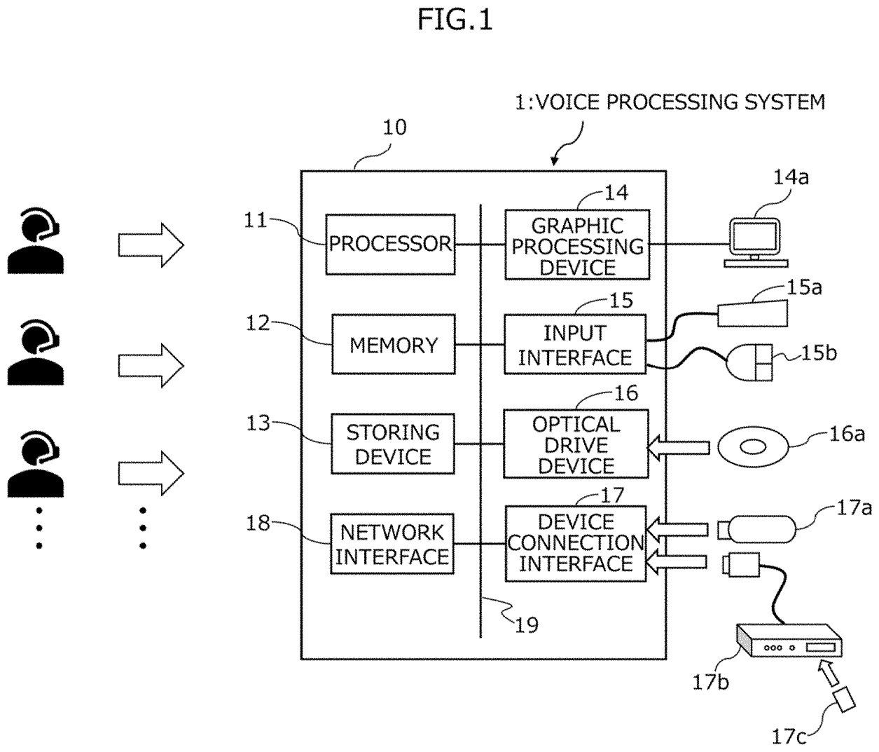

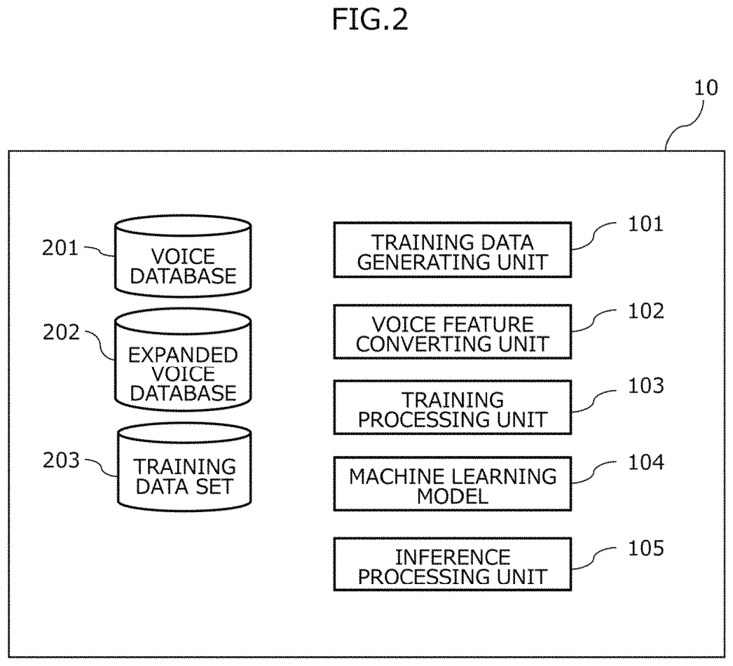

FIG. 1 is a diagram illustrating an example of the configuration of a voice processing system 1 according to an example of an embodiment, and FIG. 2 is a diagram illustrating an example of the functional configuration thereof.

The present voice processing system 1 achieves a voice clarification function that clarifies the voice of a particular sound source in an environment in which multiple sound sources each wear a microphone and the microphone worn by each voice source is moved with the movement of the voice source.

Clarification of the sound is achieved by removing a sound (noise) output from a sound source different from a sound source that outputs the voice that is the clarification target from the voice collected by the microphone worn by the sound source of the target, and clarifying (extracting and isolating) the voice output from the sound source of the target.

The present embodiment describes an example in which a sound source is a person (speaker) and each speaker wears a microphone, such as a pin microphone, that is movable with the movement of the speaker. The speaker (the sound source) that outputs the voice to be clarified (clarification target) may be referred to as a main speaker.

A microphone is worn by one voice source, and the sound source and the microphone have a one-to-one correspondence relationship. Hereinafter, a microphone worn by a speaker may be referred to as a speaker's microphone. The voice captured by a speaker's microphone is sometimes referred to as the speaker's microphone voice. In addition, the terms “voice” and “sound” each include both voice and sound.

The voice processing system 1 includes an information processing apparatus 10. Into the information processing apparatus 10, the voices of the microphones worn one by each of the multiple speakers are inputted.

For example, the information processing apparatus 10 includes, as components, a processor 11, a memory 12, a storing device 13, a graphic processing apparatus 14, an input interface 15, an optical drive device 16, a device connection interface 17, and a network interface 18. These components 11-18 are communicable to one another via a bus 19.

The processor 11 controls the overall information processing apparatus 10. The processor 11 may be a multiprocessor. Examples of the processor 11 may be a CPU (Central Processing Unit), an MPU (Micro Processing Unit), a DSP (Digital Signal Processor), an ASIC (Application Specific IC), a PLD (Programmable Logic Device), an FPGA (Field-Programmable Gate Array), and a GPU (Graphics Processing Unit). Alternatively, the processor 11 may be a combination of two or more of a CPU, an MPU, a DSP, an ASIC, a PLD, an FPGA, and a GPU.

By executing a control program (program for generating a model, program for processing voice, OS program) for the information processing apparatus 10, the processor 11 functions as a training data generating unit 101, a voice feature converting unit 102, a training processing unit 103, a machine learning model 104, and an inference processing unit 105, as illustrated in FIG. 2. The term OS is an abbreviation of Operating System.

Furthermore, by executing a program (program for generating a model, OS program) recorded in a non-transitory computer-readable recording medium, for example, the information processing apparatus 10 achieves the function as a training data generating unit 101, a voice feature converting unit 102, a training processing unit 103, and a machine learning model 104.

Furthermore, by executing a program (program for processing voice, OS program) recorded in a non-transitory computer-readable recording medium, for example, the information processing apparatus 10 achieves the function as the training data generating unit 101, the voice feature converting unit 102, and the machine learning model 104.

A program describing a processing contents that the information processing apparatus 10 is caused to execute can be stored in various recording medium. For example, a program that the information processing apparatus 10 is caused to execute may be stored in the storing device 13. The processor 11 loads at least part of a program in the storing device 13 into the memory 12 and executes the loaded program.

The program that the information processing apparatus 10 (processor 11) is caused to execute can be stored in a non-transitory portable recording medium such as an optical disc 16a, a memory device 17a, and memory card 17c. The program stored in a portable recording medium is installed into the storing device 13 under the control of the processor 11, for example, and then comes to be executable. Alternatively, the processor 11 can directly read the program from the portable recording medium and execute the program.

The memory 12 is a storing memory including a ROM (Read Only Memory) and a RAM (Random Access Memory). The RAM of the memory 12 is used as a main storing device of the information processing apparatus 10. The RAM temporarily stores at least part of the program that the processor 11 is caused to execute. The memory 12 stores various data required for processing by the processor 11.

The storing device 13 is a storing device such as an HDD (Hard Disk Drive), a semiconductor drive device such as an SSD (Solid State Drive), and stores various data. The storing device 13 is used as an auxiliary storing device of the information processing apparatus 10. The storing device 13 stores the OS program, a control program, and various data. The control program includes the program for generating a model and a program for processing voice.

In the storing device 13, data including a voice database 201, an expanded voice database 202, and a training data set 203 may be stored.

Example of the auxiliary storing device is a semiconductor storing device such as an SCM and a flash memory. In addition to the above, a RAID (Redundant Arrays of Inexpensive Disks) may be formed by using multiple storing devices 13.

The storing device 13 may store various data generated when the training data generating unit 101, the voice feature converting unit 102, the training processing unit 103, and the inference processing unit 105 that are described above execute the processes.

To the graphic processing apparatus 14, a monitor 14a is connected. The graphic processing apparatus 14 displays images on the screen of the monitor 14a in obedience to an instruction from the processor 11. An example of the monitor 14a is a displaying device using a CRT (Cathode Ray Tube) and a LCD.

To the input interface 15, a keyboard 15a and a mouse 15b are connected. The input interface 15 transmits signals transmitted from the keyboard 15a and the mouse 15b to the processor 11. The mouse 15b is an example of a pointing device and may be replaced with another pointing device, such as a touch panel, a tablet terminal, a touch pad, and a track ball.

The optical drive device 16 reads data stored in an optical disc 16a, using laser light, for example. The optical disc 16a is a non-transitory portable recording medium in which data is readably stored by means of light reflection. Examples of the optical disc 16a are a DVD (Digital Versatile Disc), a DVD-RAM, a CD-ROM (Compact Disc Read Only Memory), and a CD-R/RW (Recordable/ReWritable).

The device connection interface 17 is a communication interface to connect a peripheral device to the information processing apparatus 10. For example, to the device connection interface 17, a memory device 17a and a memory reader/writer 17b can be connected. The memory device 17a is a non-transitory recording medium equipped with a communication function with the device connection interface 17, and is exemplified by a USB (Universal Serial Bus) memory. The memory reader/writer 17b writes data into a memory card 17c and reads data from the memory card 17c. The memory card 17c is a non-transitory recording medium of card type.

The network interface 18 is connected to a network. The network interface 18 sends and receives data via a network. To the network interface 18, another information processing apparatus and another communication device may be connected.

At least part of the voice database 201, the expanded voice database 202, and the training data set 203 may be provided to another information processing apparatus connected to the information processing apparatus 10 via a network.

In the voice processing system 1, by the processor 11 executing the program for generating model, the functions of the training data generating unit 101, the voice feature converting unit 102, the training processing unit 103 are achieved. The training data generating unit 101, the voice feature converting unit 102, the training processing unit 103 function in a training phase.

By the processor 11 executing the program for processing voice, the function as the inference processing unit 105 is achieved. The inference processing unit 105 functions in the inference phase.

A voice database 201 stores a voice (recorded voice) of each of multiple speakers individually recorded with a microphone in advance. It is desirable that these recorded voices are free from noise, such as environmental sounds, and furthermore, the recorded voice of each speaker shall not contain the voice of any speaker different from the speaker.

In addition, it is desirable to prepare various data for the recorded voice, considering the frequency response of each type of microphone and the differences depending on data format of a voice file.

That is, the user records the speaker's voice using several types of microphones and stores the recorded voices data in several types of data formats. By changing a combination between the microphone type and the data format, the variation on the recorded voices each individual speaker can be increased.

A training data generating unit 101 generates a training data set (teacher data) 203 used to train a machine learning model (voice processing model) 104 in a training phase.

The training data set 203 includes multiple training voice sets (training data).

In the present voice processing system 1, the training voice set includes three voice data of “post-clarification main-speaker's voice to be isolated”, “pre-clarification main-speaker's voice to be isolated”, and “voice to be excluded”. These three voice data are combined into a single training voice set.

Of the training voice set, in the training phase of machine learning model 104, the pre-clarification main-speaker's voice to be isolated and the voice to be excluded are used as the input data into the machine learning model 104, and the post-clarification main-speaker's voice to be isolated is used as the answer data.

The training data generating unit 101 generates the training data set 203 by generating multiple training voice sets as the above.

The training data generating unit 101 expands (increases) data of the recorded voice by processing the recorded voices stored in the voice database 201 to further enhance the versatility.

For example, the training data generating unit 101 may perform data expansion that increases data count by processing the recorded sound through changing the format of the voice data, such as a frequency response and a sampling frequency. The training data generating unit 101 may also expand data by changing the volume of the recorded voice through changing the power (acoustic power) of the sound. The method of data extension on the recorded voice is not limited to the above, but may be appropriately modified and implemented.

The training data generating unit 101 stores recorded data subjected to expansion, which data is generated by data expansion on the recorded voice stored in the voice database 201, into the expanded voice database 202.

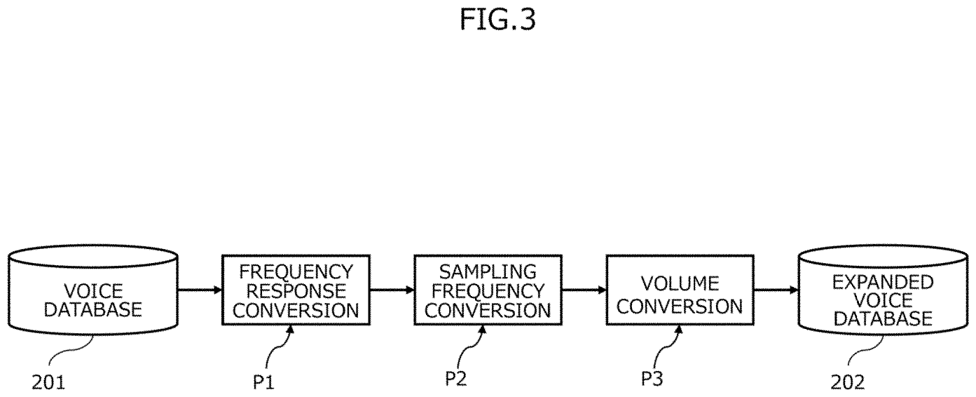

FIG. 3 is a diagram illustrating a method for generating an expanded recorded voice in the voice processing system 1 according to an example of the one embodiment.

In the method illustrated in FIG. 3, on the recorded voice read from the voice database 201, frequency response conversion (see the reference sign P1), sampling frequency conversion (see reference sign P2), and volume conversion (see reference sign P3) are performed in this order. Thereby, the voice processing system 1 generates recorded voice subjected to expansion.

The recorded voice data subjected to expansion that is generated is stored into the expanded voice database 202. The recorded voice stored in the voice database 201 is also read and stored into the expanded voice database 202.

Hereinafter, the recorded voice and the recorded voice subjected to expansion that are stored in the expanded voice database 202 may be referred to as the expanded recorded voice.

Incidentally, the method for generating recorded voice subjected to expansion is not limited to the method illustrated in FIG. 3, but may alternatively be implemented by modifying the method accordingly. For example, at least part of each of the frequency response conversion, the sampling frequency conversion, and the volume conversion may be omitted, and the order of these processes may be changed. Furthermore, in addition to the frequency response conversion, the sampling frequency conversion, and the volume conversion, another conversion may be added and implemented.

The training data generating unit 101 selects a clarified voice from the expanded recorded voice stored in the expanded voice database 202.

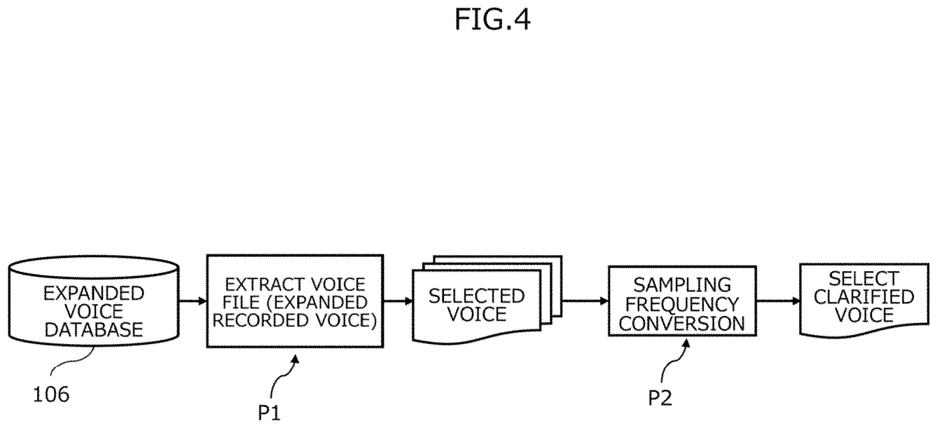

FIG. 4 is a diagram illustrating a method for selecting a clarified voice by the training data generating unit 101 in the voice processing system 1 according to an example of the one embodiment.

The training data generating unit 101 selects (extracts) multiple voice files (voice data) from the expanded recorded voices stored in the expanded recorded voice database 202 (see the reference sign P1 of FIG. 4). For example, the training data generating unit 101 may randomly select multiple expanded recorded voices from the multiple expanded recorded voices.

Further, the training data generating unit 101 selects one expanded recorded voice from among the multiple expanded recorded voices (see reference sign P2 of FIG. 4). In this way, one expanded recorded voice selected from among the multiple expanded recorded voices may be referred to as a clarified voice. For example, the training data generating unit 101 may randomly select clarified voice from among the multiple expanded recorded voices.

A clarified voice is a voice used as the answer data in the training phase of a neural network to be described below and is the post-clarification main-speaker's voice to be isolated. A neural network may be abbreviated to “NN”.

Further, the training data generating unit 101 generates a microphone voice (predicted voice) that is predicted to be collected by the microphone of each speaker by using the expanded recorded voice of the speaker stored in the expanded voice database 202.

As described above, the present voice processing system 1 assumes an environment (microphone environment) in which multiple speakers speak simultaneously, and it is assumed that the microphone of each speaker is also inputted with voice of another speaker and crosstalk occurs. In the microphone environment in which such crosstalk is assumed to occur, the predicted voice generated by the training data generating unit 101 may be referred to as the crosstalk predicted voice.

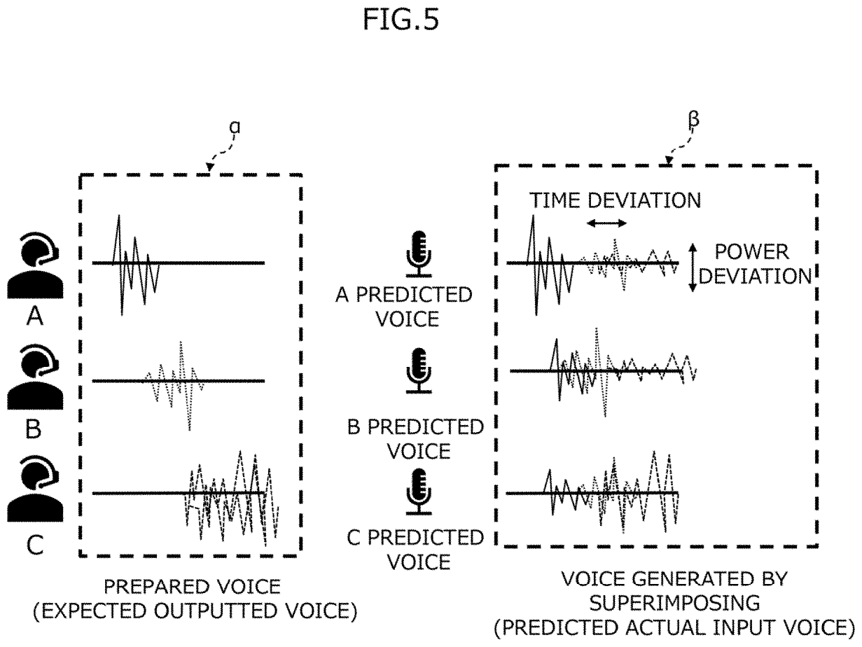

FIG. 5 is a diagram illustrating a crosstalk predicted voice generated by the training data generating unit 101 in the voice processing system 1 according to an example of the one embodiment

FIG. 5 illustrates expanded recorded voices (see symbol a) of the three speakers A, B, and C and a crosstalk predicted voice (see symbol generated using these expanded recorded voices. Here, an expanded recorded voice generated on the basis of the recorded voice of the speaker A may be referred to as an expanded recorded voice of the speaker A. Similarly, an expanded recorded voice generated on the basis of the recorded voice of the speaker B may be referred to as an expanded recorded voice of the speaker B, and an expanded recorded voice generated on the basis of the recorded voice of the speaker C may be referred to as an expanded recorded voice of the speaker C.

In FIG. 5, the expanded recorded voice of the speaker A is expressed by a solid line, the expanded recorded voice of speaker B is shown as a dotted line, and the expanded recorded voice of speaker C is shown as a dashed line, respectively.

As described above, the training data generating unit 101 generates a crosstalk predicted voice (predicted voice of the speakers) predicted to be collected to the microphone of each speaker, using the voice files (voice data) of two or more expanded recorded voices selected from among the expanded recorded voices stored in expanded voice database 202.

For example, the voice of the speaker B and the voice of the speaker C are respectively inputted into the microphone of the speaker A. For the above, the training data generating unit 101 generates a crosstalk predicted voice of the speaker A by synthesizing (superimposing) the expanded recorded voice of the speaker B and the speaker C onto the expanded recorded voice of the speaker A, for example. Here, an expanded recorded voice onto which other expanded recorded voice is to be superimposed may be referred to as a major expanded recorded voice. Further, another expanded recorded voice to be superimposed onto a major expanded recorded voice may be referred to as a minor expanded recorded voice. The major expanded recorded voice is an example of a first expanded recorded voice, and the minor expanded recorded voice is an example of a third expanded recorded voice.

On this occasion, the distance between the microphone of the speaker A and the speaker B and the distance between the microphone of the speaker A and the speaker C are each further than the distance between the microphone of the speaker A and the speaker A.

Consequently, the voices of the speaker B and the speaker C are delayed before reaching the microphone of the speaker A, and the volumes of the voices lower (i.e., the powers of the voices may be lower). In addition, the orientation (direction of voice) of each of the speakers A, B, and C may also affect the voice to be inputted into the microphones.

The training data generating unit 101 reflects such relative relationships (position, orientation, etc.) between a microphone and each speaker in a crosstalk predicted voice.

Specifically, in generating a crosstalk predicted voice, the training data generating unit 101 superimposes an expanded recorded voice (minor expanded recorded voice) of a speaker other than a particular speaker onto the expanded recorded voice (major expanded recorded voice) of the particular speaker. At this time, the training data generating unit 101 performs a delaying process and a volume conversion process on the expanded recorded voice (minor expanded recorded voice, an example of a second expanded recorded voice) of the other speaker.

For example, with respect to the cross-talk predicted voice of the speaker A, the training data generating unit 101 performs a delaying process on the expanded recorded voices (the minor (second) expanded recorded voices) of the speaker B and the speaker C such that the expanded recorded voices (the minor expanded recorded voices) of the speaker B and the speaker C are delayed from the expanded recorded voice (the major (first) expanded recorded voice) of the speaker A. Then, the expanded recorded voices (minor (third) expanded recorded voices) of the speaker B and the speaker C having been subjected to the delaying process as the above are superimposed onto the expanded recorded voice of the speaker A (major expanded recorded voice).

This means that the training data generating unit 101 superimposes the expanded recorded voice of the speaker B and the expanded recorded voice of the speaker C delayed from the expanded recorded voice of the speaker A onto the expanded recorded voice of the speaker A in the crosstalk predicted voice of the speaker A.

Thus, in the crosstalk predicted voice of the speaker A, a deviation (time deviation) in the time direction occurs so that each of the expanded recorded voices of the speaker B and the speaker C are delayed for, for example, a few milliseconds from the expanded recorded voice of the speaker A.

Similarly, for the crosstalk predicted voice of the speaker B, the training data generating unit 101 superimposes the expanded recorded voice (minor expanded recorded voice) of the speaker A and the expanded recorded voice (minor expanded recorded voice) of the speaker C for which time deviations have been generated onto the expanded recorded voice (the major expanded recorded voice) of the speaker B. Furthermore, for the crosstalk predicted voice of the speaker C, the training data generating unit 101 superimposes the expanded recorded voice (minor expanded recorded voice) of the speaker A and the expanded recorded voice (minor expanded recorded voice) of the speaker B for which time deviations have been generated onto the expanded recorded voice (the major expanded recorded voice) of the speaker C.

Further, for the crosstalk predicted voice of the speaker A, the training data generating unit 101 performs a volume conversion process on each of the expanded recorded voices (minor expanded recorded voices) of the speaker B and the speaker C such that the power of the expanded recorded voices (minor expanded recorded voices) of the speaker B and the speaker C come to be smaller than that of the expanded recorded voice (major expanded recorded voice) of the speaker A. This expanded recorded voices of the speaker B and the speaker C having been subjected to volume conversion process as the above are superimposed onto the expanded recorded voice of the speaker A.

In other words, for the crosstalk predicted voice of the speaker A, the training data generating unit 101 superimposes the expanded recorded voices (minor expanded recorded voices) of the speaker B and the speaker C whose volumes are lowered as compared with that of the expanded recorded voice (major expanded recorded voice) of the speaker A onto the expanded recorded voice (major expanded recorded voice) of the speaker A.

Consequently, in the crosstalk predicted voice of the speaker A, the expanded recorded voices of the speaker B and the speaker C have a deviation (power deviation) with respect to the expanded recorded voice of the speaker A.

Similarly, in the crosstalk predicted voice of the speaker B, the training data generating unit 101 superimposes the expanded recorded voices (minor expanded recorded voices) of the speaker A and the speaker C whose volumes are lowered as compared with that of the expanded recorded voice (major expanded recorded voice) of the speaker B onto the expanded recorded voice (major expanded recorded voice) of the speaker B. Further, the training data generating unit 101 superimposes the expanded recorded voices (minor expanded recorded voices) of the speaker A and the speaker B whose volumes are lowered as compared with that of the expanded recorded voice (major expanded recorded voice) of the speaker C onto the expanded recorded voice (major expanded recorded voice) of the speaker C.

That is, for a crosstalk predicted voice of a particular speaker, the training data generating unit 101 causes one or more expanded recorded voices (minor expanded recorded voice) of speakers other than the particular speaker to each have a power deviation and a time deviation and superimposes the expanded recorded voices of the other speakers onto the expanded recorded voice (major expanded recorded voice) of the particular speaker. Incidentally, the amount of power deviation and the amount of time deviation can be appropriately changed and implemented.

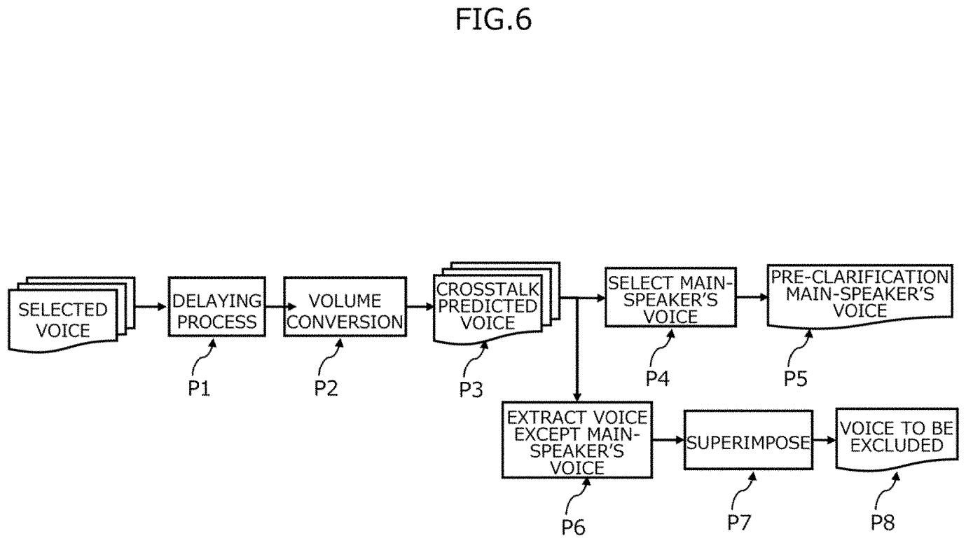

FIG. 6 is a diagram illustrating a method for generating a training data (training voice set) by the training data generating unit 101 in the voice processing system 1 according to an example of the one embodiment

In the method of generating the training voice set illustrated in FIG. 6, multiple crosstalk predicted voices (see the reference sign P3 of FIG. 6) are first generated in the method described manner. Then, using these multiple of crosstalk predicted voices, a pre-clarification main-speaker's voice (see the reference sign P5 of FIG. 6) and a voice to be excluded (see the reference sign P8 of FIG. 6) are generated.

First, the training data generating unit 101 selects an expanded recorded voice (major expanded recorded voice) of a single speaker (first speaker) from among multiple expanded recorded voices selected from the expanded voice database 202 and generates a crosstalk predicted voice of the first speaker.

The training data generating unit 101 performs the delaying process (see the reference sign P1 in FIG. 6) and the volume conversion process (see reference sign P2 in FIG. 6) on an expanded recorded voice (the minor expanded recorded voice) of a speaker (second speaker) other than the above one speaker (the first speaker) among the multiple expanded recorded voices selected from the expanded voice database 202. Here, two or more second speakers may be selected.

The training data generating unit 101 generates a crosstalk predicted voice, which is predicted to be collected with the microphone of the first speaker, by superimposing the expanded recorded voice (miner expanded recorded voice) of the second speaker having been subjected to the delaying process and the volume conversion process on the expanded recorded voice (the major expanded recorded voice) of the first speaker.

The training data generating unit 101 generates respective crosstalk predicted voices of the multiple speakers registered in the expanded voice database 202 by repeatedly executing the processes of the reference signs P1 and P2 on the expanded recorded voices of the multiple speakers while changing the delay amount and the volume conversion amount appropriately (see the reference sign P3 of FIG. 6).

The training data generating unit 101 selects one crosstalk predicted voice (first crosstalk predicted voice) of the main speaker from among the multiple generated crosstalk predicted voices (see the reference sign P4 of FIG. 6). The crosstalk predicted voice of the main speaker selected in this manner is used as the pre-clarification main-speaker's voice (first training data) to be isolated (see the reference sign P5 of FIG. 6).

The selection of the crosstalk predicted voice of the main speaker from among the multiple crosstalk predicted voices may be made at random and may be modified accordingly.

In addition, the training data generating unit 101 extracts a crosstalk predicted voice (second crosstalk predicted voice) of a speaker other than the crosstalk predicted voice of the main speaker selected as the above from among the multiple generated crosstalk predicted voices (see the reference sign P6 of FIG. 6). Then, the training data generating unit 101 superimposes these crosstalk predicted voices other than the crosstalk predicted voice of the main speaker (see the reference sign P7 of FIG. 6). As the above, the voice signal obtained by superimposing crosstalk predicted voices other than that of the main speaker is used as a voice to be excluded (the second training voice data) (see the reference sign P8 of FIG. 6).

The pre-clarification main-speaker's voice (the crosstalk predicted voice of the main speaker) to be isolated and the voice (voices signal obtained by superimposing crosstalk predicted voices other than that of the main speaker) to be excluded are used as inputted data into the machine learning model 104, which will be described below.

The training data generating unit 101 combines the three voices of the “post-clarification main-speaker's voice to be isolated”, the “pre-clarification main-speaker's voice to be isolated”, and the “voice to be excluded” that are selected and generated as the above into one training voice set. Then, the training data generating unit 101 generates multiple training voice sets by repeating the above process using the training voice sets. These multiple training voice sets are stored as training data set 203 in a predetermined storing region, such as the storing device 13.

The voice feature converting unit 102 encodes voice data so that the encoded voiced data can be used as an input into the machine learning model 104. In the training phase, the voice feature converting unit 102 converts the feature of the respective data of the “pre-clarification main-speaker's voice to be isolated” and the “voice to be excluded” that are generated by the training data generating unit 101. In addition, in the inference phase, the voice feature converting unit 102 performs feature conversion on the main voice to be clarified and the superimposed voice (to be detailed below) except for the main voice.

The voice feature converting unit 102 converts, for example, voice data represented by a relationship between time and amplitude into a data represented by a relationship between time and frequency by a feature conversion.

The voice feature converting unit 102 achieves the feature conversion on a voice using various known techniques such as, for example, spectrogram transformation or MFCC (Mel-Frequency Cepstrum Coefficient). The voice feature converting unit 102 may perform time-frequency analysis that Fourier-transforms a voice and resolves the voice by a frequency component or an intensity.

In the inference phase, the voice feature converting unit 102 also adjusts the power of the signal of the voice to be excluded that the training data generating unit 101 generates. While the main voice to be clarified is a single voice data, the superimposed voice other than the main voice is obtained by superimposing multiple voice data as described below. Considering the above, the voice feature converting unit 102 adjusts the power level of the superimposed voice other than the main voice by, for example, attenuation, so that the power level of the superimposed voice comes to be equal to the power level of the main sound.

The training processing unit 103 performs training (machine learning) on the machine learning model 104, using the training data set.

The machine learning model 104 is, for example, a neural network, and outputs “post-clarification main-speakers voice” in response to inputting of the “pre-clarification main-speaker's voice” and “voice to be excluded”.

The training processing unit 103 generates the machine learning model 104 by machine-learning using training data. The training data is a data that associates first training voice data (pre-clarification main-speaker's voice to be isolated) obtained with a microphone associated with the source of a first voice (main voice, speaker), second training voice data (voice to be excluded) obtained from a microphone other than the main voice, and the clarified training voice data (post-clarification main-speaker's voice to be isolated) obtained by clarifying the voice contained in at least one of the first training voice data and the second training voice data with one another.

The neural network may be a hardware circuit or a software-based virtual network connecting hierarchies that are virtually constructed on a computer program by the processor 11. A neural network is sometimes referred to as NN.

The training processing unit 103 trains the machine learning model 104 with data that uses the “pre-clarification main-speaker's main voice to be isolated” and the “voice to be excluded” having been encoded by the voice feature converting unit 102 as the input data and also uses the expanded recorded voice of the main speaker as the answer data. The training processing unit 103 repeats updating of parameters of the neural network of the machine learning model 104 such that an error between the “post-clarification main-speaker's voice to be isolated)” serving as the output of the machine learning model 104 and the answer data (expanded recorded voice) comes to be smaller.

In addition, the “pre-clarification main-speaker's main voice to be isolated” and the “voice to be excluded” that used as the input data are each crosstalk predicted voice generated by predicting crosstalk. A crosstalk predicted voice is characterized by having a deviation in the time direction (time-axis direction).

Considering the characteristics of such a crosstalk predicted voice, the present voice processing system 1 carries out convolution in the time direction on the “pre-clarification main-speaker's main voice to be isolated” and the “voice to be excluded” separately each other, so that the accuracy of the clarification is enhanced by reducing the deviations in the time direction.

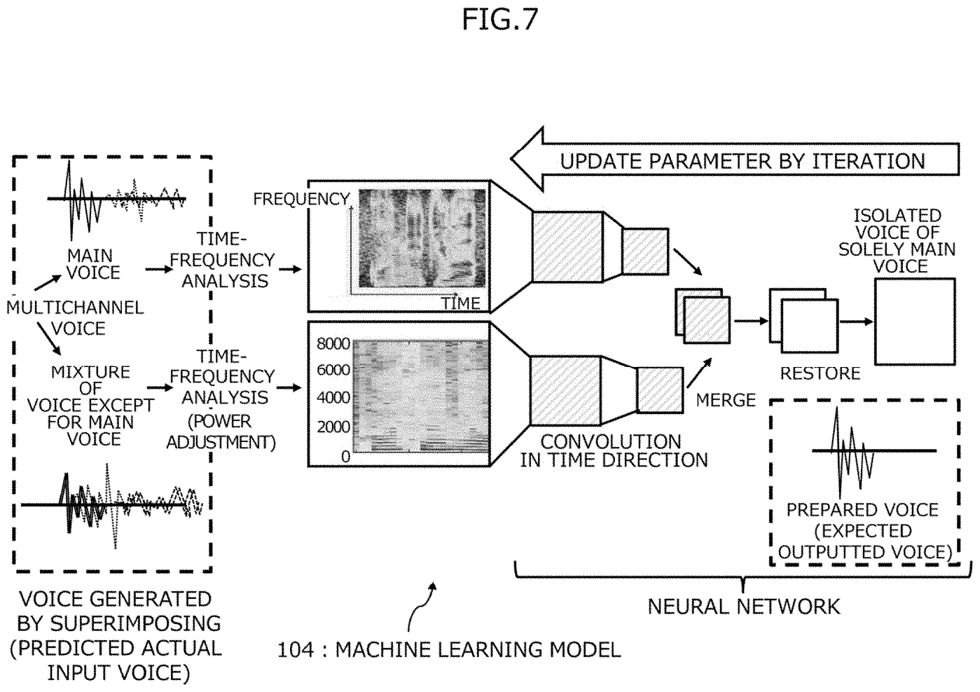

FIG. 7 is a diagram illustrating a process in the training phase performed by the training processing unit 103 in the voice processing system 1 according to an example of the one embodiment.

The neural network of the machine learning model 104 includes one or more convolutional layers, a merging layer, and a restoring layer.

The convolutional layers perform convolution in the time direction on data generated by the feature conversion by the voice feature converting unit 102. This convolution in the time direction absorbs a deviation in the time direction of multiple predicted voices contained in the crosstalk predicted voice.

As described above, into the machine learning model 104, two voice data of “pre-clarification main-speaker's main voice to be isolated” and the “voice to be excluded” are input and the multiple convolutional layers each carry out a convoluting process on these voice data.

The merging layer merges an output data generated by the convolutional layer convoluting the “pre-clarification main-speaker's voice to be isolated” and output data generated by the convolutional layer convoluting the “voice to be excluded.

The restoring layer restores individual expanded recorded voices from the output data merged and outputted by the merging layer.

As the above, the machine learning model 104 carries out the merging and the restoring after convoluting the two voice data of the “pre-clarification main-speaker's voice to be isolated” and the “voice to be excluded” that are inputted in the time direction.

The machine learning model 104 extracts the expanded recorded voice of the main voice from the restored expanded recorded voices and outputs the extracted voice as the inference result.

The training processing unit 103 generates the machine learning model 104 by optimizing parameter, such as a weight, of the neural network on the basis of the inference result of the machine learning model 104 and “post-clarification main-speaker's voice to be isolated” (answer data).

The training processing unit 103 may, for example, optimize the parameter by updating, by the gradient descent method, the parameter of the neural network in a direction of reducing the loss function that defines an error between the inference result of the training processing unit 103 on the training data and the answer data.

The inference processing unit 105 executes inferences, using the machine learning model 104, in the inference phase.

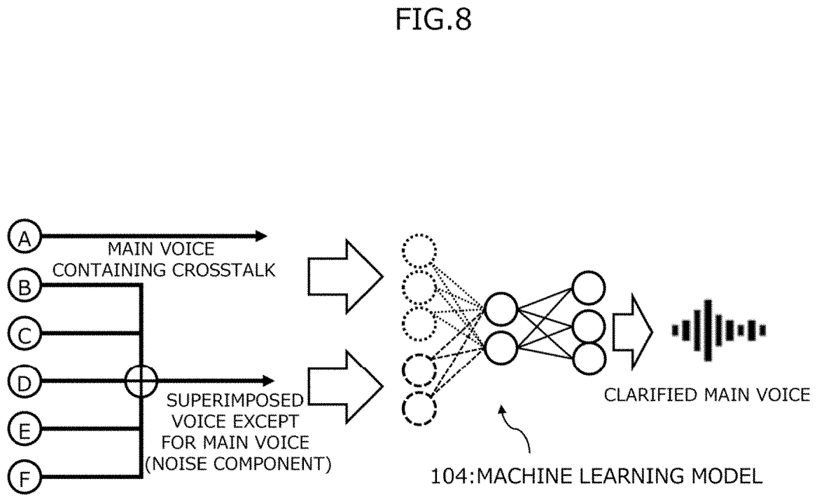

FIG. 8 is a diagram illustrating input data in the inference phase of machine learning model 104 in the voice processing system 1 according to an example of the one embodiment.

The inference processing unit 105 inputs the main voice (see reference symbol A of FIG. 8, an example of first inference voice data) including crosstalk and the superimposed voice (an example of second inference voice data) other than the main voice (see reference symbols B to F of FIG. 8) into the machine learning model 104. The main voice including crosstalk is the voice to be clarified. In addition, the superimposed voice other than the main voice are the voice (noise components) to be excluded.

The machine learning model 104 removes the crosstalk (noise component) from the main voice including crosstalk, and outputs the clarified main voice.

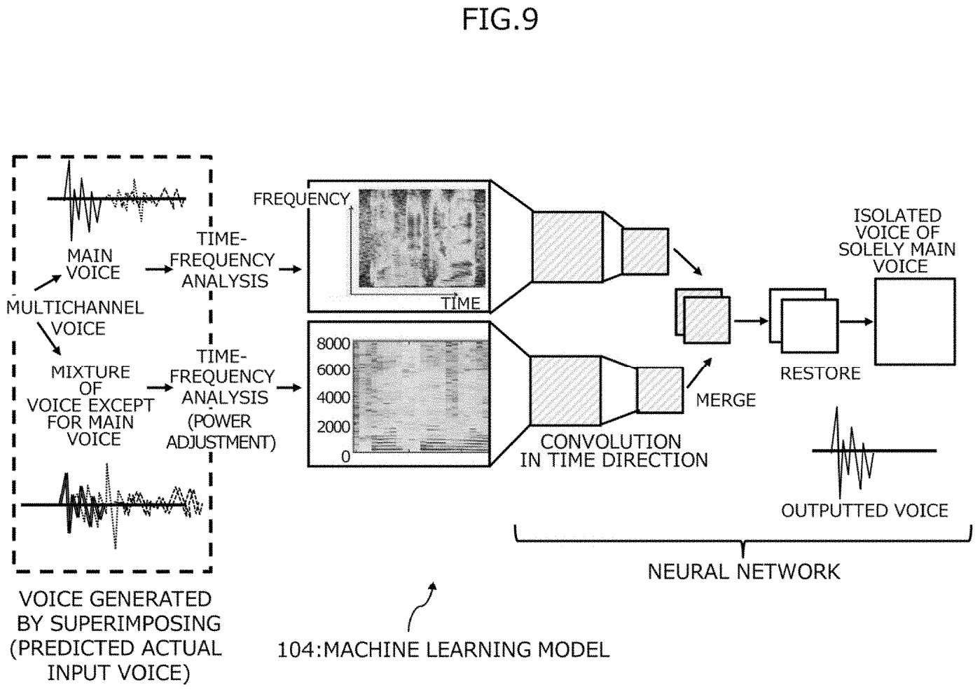

FIG. 9 is a diagram illustrating a process in the inference phase performed by then inference processing unit 105 in the voice processing system 1 according to an example of the one embodiment.

The inference processing unit 105 inputs, into the voice feature converting unit 102, the main voice to be clarified and the superimposed voice (superimposed voice other than the main voice) obtained by superimposing expanded recorded voices other than the main voice, and then causes the voice feature converting unit 102 to carry out time-frequency analysis (feature conversion) on these voice data. At this time, the voice feature converting unit 102 also performs power adjustment of the superimposed voice other than the main voice.

The machine learning model 104 carries out the merging and the restoring on the two voice data converted by the voice feature converting unit 102 after convolution in the time direction on the two voice data. The machine learning model 104 extracts the clarified main voice from the restored voices and outputs the extracted voice as the inference result.

<B> Operation:

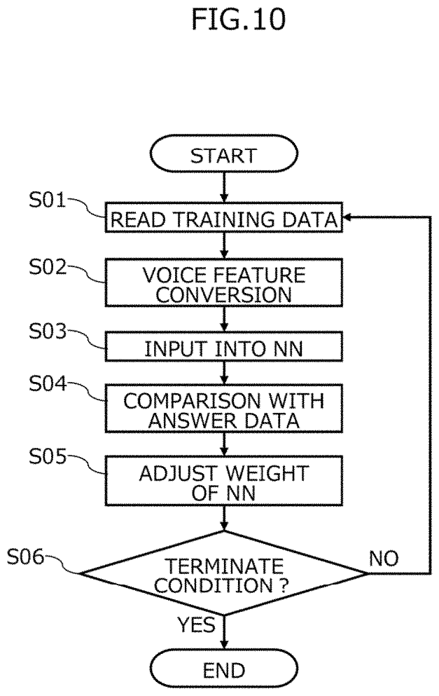

Description will now be made in relation to a process of the training phase in the voice processing system 1 according to an example of an embodiment configured as described above with reference to the flow diagram (Steps S01˜S06) of FIG. 10.

In Step S01, the training processing unit 103 reads the training data (voice data sets) from the expanded voice database 202.

In Step S02, the training processing unit 103 inputs the “pre-clarification main-speaker's voice to be isolate” and the “voice to be excluded” contained in the voice data sets into the voice feature converting unit 102 to undergo the feature conversion.

The voice feature converting unit 102 converts the features of the respective data of the “pre-clarification main-speaker's voice to be isolated” and the “voice to be excluded”.

In Step S03, the training processing unit 103 trains the machine learning model 104 (neural network). The training data is one that uses the “pre-clarification main-speaker's main voice to be isolated” and the “voice to be excluded” that are encoded by the voice feature converting unit 102 as input data and also uses the expanded recorded voice of the main speaker as the answer data.

In the machine learning model 104, each convolutional layer performs convolution in the time direction on each of the two inputted voice data having been subjected to the feature conversion. In addition, the merging layer merges the two output data outputted from the convolutional layer. Then the restoring layer restores individual expanded recorded voices from the output data merged and outputted by the merging layer.

Then, the machine learning model 104 extracts the expanded recorded voice of the main voice from the restored expanded recorded voices and outputs the extracted voice as the inference result.

In Step S04, the training processing unit 103 causes the machine learning model 104 to compare the inference result that the machine learning model 104 outputs on the basis of the input data with the answer data.

In Step S05, the training processing unit 103 optimizes the parameter, such as a weight, by causing the machine learning model 104 to update, by the gradient descent method, the parameter of the neural network in a direction of reducing the loss function that defines an error between the inference result of the training processing unit 103 on the training data and the answer data.

In Step S06, the training processing unit 103 confirms whether the terminate condition for terminating the training is satisfied. For example, the training processing unit 103 may determine that the terminate condition is satisfied when the number of trainings performed by using the training data (voice data sets) reaches a given epoch number or when the accuracy of the machine learning model 104 reaches a predetermined threshold.

If the terminate condition for training is not satisfied (see NO route in Step S06), the process returns to Step S01. If the terminate condition for training is satisfied (see YES route in Step S06), the process terminates.

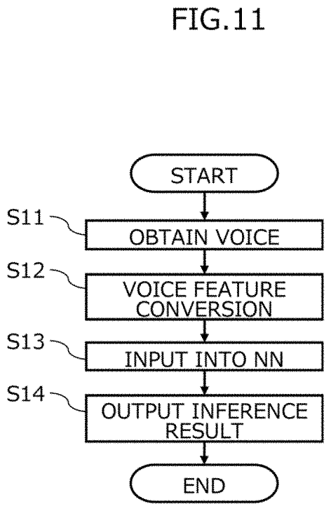

Next, description will now be made in relation to a process of the inference phase in the voice processing system 1 according to an example of the embodiment with reference to the flow diagram (Steps S11-S14) of FIG. 11.

In Step S11, the inference processing unit 105 obtains the main voice to be clarified and the superimposed voice other than the main voice.

In Step S12, the inference processing unit 105 inputs the main voice and the superimposed voice other than the main voice into the voice feature converting unit 102 to undergo a feature conversion.

The voice feature converting unit 102 performs feature conversion on each data of the main voice and the superimposed voice other than the main voice.

In the Step S13, the inference processing unit 105 inputs the main voice and the superimposed voice other than the main voice having been encoded by the voice feature converting unit 102 into the machine learning model 104 (neural network).

In the machine learning model 104, the convolutional layer performs convolution in the time direction on each of the two inputted voice data having been subjected to feature conversion. In addition, the merging layer merges the two output data outputted from the convolutional layer. Then the restoring layer restores individual voices from the output data merged and outputted by the merging layer.

In Step S14, the inference processing unit 105 causes the machine learning model 104 to extract the expanded recorded voice of the main voice from the restored voices and outputs the extracted main voice as the inference result.

<C> Effect

As described above, in the voice processing system 1 as an example of one embodiment, the training data generating unit 101 generates multiple types of crosstalk predicted voices (training data) of the two inputs of the “pre-clarification main-speaker's voice to be isolated” and the “voice to be excluded”, considering a case where deviations of power and time occur in the two inputs.

In the training phase, the machine learning model 104 is trained using the training data that reflects these crosstalk predicted voices. This makes it possible to improve the accuracy of the machine learning model 104 because the microphone environment predicting the occurrence of crosstalk is reflected in the training of the machine learning model 104. Consequently, a clear speech of the voice of the nearest microphone can be obtained and can be used for voice recognition, detection of speech range, and the like. Also, even if the speaker and microphone are moved, the clear voice of the main speaker can be obtained.

Updating of the parameters of the neural network in the training phase eliminates the need for repeating updating of the parameters in the inference phase. This can, for example, reduce calculation costs.

In the inference phase, the machine learning model 104 (neural network) convolutes, in the time direction, respective data of the main voice to be clarified and the superimposed voice other than the main voice which has been subjected to feature conversion by the inference processing unit 105, and then merges and restores the respective data.

This enables proper isolation of a sound source even if a deviation of time occurs in a voice obtained by superimposing voices other than the main voice. In addition, even when the sound source (speaker) and the microphone are moving, the main voice can be appropriately clarified.

Furthermore, in an environment in which microphones are worn one by each of the multiple speakers (the voice sources) and the microphone worn by each speaker is also moved according to the movement of the speaker, only the voice of the target speaker can be clarified (extracted and isolated) regardless of the number of microphones (the number of speakers).

Even in a multi-channel environment, a certain constant processing speed can be maintained by superimposing the voice data except for the main voice to be isolated.

The machine learning model 104 (Neural Network) convolutes, in the time direction, the main voice and the voice obtained by superimposing voices other than the main voice. This enables proper isolation of a sound source even if a deviation of time occurs in a voice obtained by superimposing voices except for the main voice.

The training data generating unit 101 can easily expand (increase) data of the recorded voice by carrying out a process, such as frequency response conversion, sampling data frequency conversion, and volume conversion, on the recorded voices obtained with a microphone.

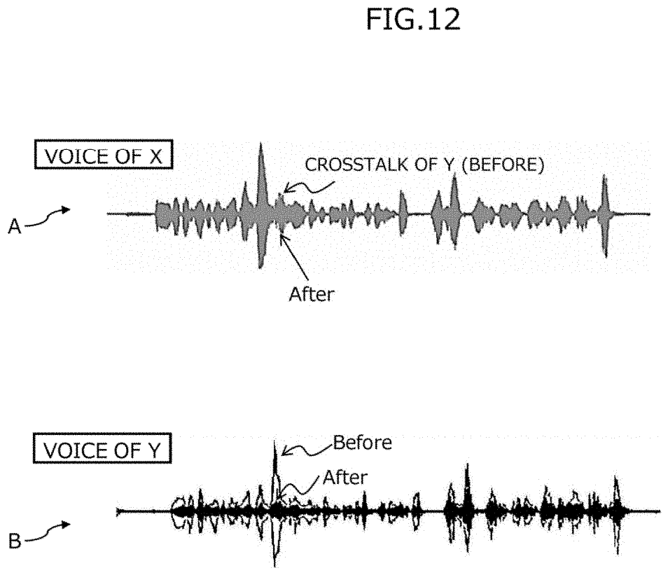

FIG. 12 is a diagram illustrating an inference result in the voice processing system 1 according to an example of the one embodiment.

FIG. 12 illustrates the microphone voice of a speaker X and the microphone voice of a speaker Y in an environment in which two speakers X and Y simultaneously speak. It is assumed that the microphone of the speaker Y receives the voice of the speaker X as a crosstalk in addition to the voice of the speaker Y.

Here, the reference symbol A represents an inference result when the microphone voice of the speaker X and the microphone voice of the speaker Y are used as the input data, the voice of the speaker X is used as the clarification target (main voice), and the voice of the speaker Y is used as the input other than the main voice.

In this reference symbol A, the voice of the speaker Y slightly appears at the tip of the voice waveform of the speaker X (see crosstalk of Y). A pre-clarification voice in which the voice of the speaker Y is mixed and which is collected with the microphone, is expressed as “Before”. The voice of the speaker X clarified and outputted by the present voice processing system 1 is represented as a “After”.

On the other hand, the reference symbol B represents an inference result when the microphone voice of the speaker X and the microphone voice of the speaker Y are used as the input data, the voice of the speaker Y is used as the clarification target (main voice), and the voice of the speaker X is used as the input other than the main voice.

This reference symbol B illustrates the pre-clarification voice (Before) collected with the microphone of the speaker Y and the voice (After) having been clarified and outputted by clarifying the voice of the speaker Y by the voice processing system 1.

In FIG. 12, as illustrated by reference symbol A, when the voice of the speaker X is input as the voice to be clarified, since the pre-clarification voice (Before) collected with the microphone of the speaker X and the post-clarification voice (After) obtained by clarifying the voice of the speaker X by the present voice processing system 1 and then outputted are almost equal, it can be understood that there is little negative effect (see reference symbol A).

On the other hand, as indicated by the reference symbol B, even if the voice of speaker Y in which crosstalk frequently occurs is input into the voice to be clarified, it can be confirmed that the crosstalk of speaker X is attenuated and the voice of the speaker Y is clarified in the voice of After.

<D> Miscellaneous:

The respective configurations and processes of the present embodiment can be selected, omitted, and combined according to the requirement.

The disclosed techniques are not limited to the embodiment described above, and may be variously modified without departing from the scope of the present embodiment.

For example, the above-described embodiment describes a manner to eliminate crosstalk of the voices of multiple speakers, but the application of the embodiment is not limited to this.

For example, as an alternative to attenuation of the voice of a speaker inputted as a crosstalk, the embodiment may be applied to removal of specific noise in the voice. For example, in a concert venue, played music may be clarified by preparing a microphone for collecting environmental sounds and applause sounds and attenuating such environmental sounds and applause inputted, as crosstalk, into another microphone to collect the played music.

Further, in the present voice processing system 1, a noise canceling system may be achieved by processing voices collected from multiple microphones in real time.

In addition, those ordinary skilled in the art can carry out and manufacture of the present embodiments with reference to this disclosure.

According to the one embodiment, even when a voice source is moved, the voice can be clarified.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
generating a voice processing model by executing machine learning using training data, the training data associating first training voice data obtained with a first microphone, second training voice data obtained with a second microphone different from the first microphone, and clarified training voice data with one another, the clarified training voice data being obtained by a clarifying process on voice contained at least one of the first training voice data and the second training voice data, the voice processing model generating clarified voice data in response to input of first inference voice data and second inference voice data.

2. The non-transitory computer-readable recording medium according to claim 1, the process further comprising:
generating a plurality of expanded recorded voices by processing the first training voice data and the second training voice data;
generating a crosstalk predicted voice by superimposing a third expanded recorded voice onto a first expanded recorded voice, the first expanded recorded voice being one selected from among the plurality of expanded recorded voices, the third expanded being obtained by performing a delaying process and a volume conversion process on a second expanded recorded voice among the plurality of expanded recorded voices except for the first expanded recorded voice;
selecting a first crosstalk predicted voice, as the first training voice data, from among a plurality of the crosstalk predicted voices; and
generating the second training voice data by superimposing a plurality of second crosstalk predicted voices selected from among the plurality of crosstalk predicted voices except for the first crosstalk predicted voice.

3. The non-transitory computer-readable recording medium according to claim 1, the process further comprising:
causing the voice processing model to convolute each of the first training voice data, the second training voice data, the first inference voice data, and the second inference voice data in a time direction.

4. The non-transitory computer-readable recording medium according to claim 1, the process further comprising:
generating the clarified voice data by inputting the first inference voice data and the second inference voice data into the voice processing model.

5. The non-transitory computer-readable recording medium according to claim 4, wherein:
the first training voice data is a first crosstalk predicted voice selected from a plurality of crosstalk predicted voices,
the second training voice data is obtained by superimposing two or more second crosstalk predicted voices selected from among the plurality of crosstalk predicted voices except for the first crosstalk predicted voice,
each of the plurality of crosstalk predicted voices are generated by superimposing a third expanded recorded voice onto a first expanded recorded voice, the first expanded recorded voice being selected from among a plurality of expanded recorded voices generated by processing the first training voice data and the second training voice data, the third expanded recorded voice being obtained by performing on a delaying process and a volume converting process on a second expanded recorded voice, the second expanded recorded voice being one among the plurality of expanded recorded voice and being different from the first expanded recorded voice.

6. The non-transitory computer-readable recording medium according to claim 4, the process further comprising:
causing the voice processing model to convolute each of the first training voice data, the second training voice data, the first inference voice data, and the second inference voice data in a time direction.

7. An information processing apparatus comprising:
a memory; and
a processor coupled to the memory, the processor being configured to:
generate a voice processing model by executing machine learning using training data, the training data associating first training voice data obtained with a first microphone, second training voice data obtained with a second microphone different from the first microphone, and clarified training voice data with one another, the clarified training voice data being obtained by a clarifying process on voice contained at least one of the first training voice data and the second training voice data, the voice processing model generating clarified voice data in response to input of first inference voice data and second inference voice data.

8. The information processing apparatus according to claim 7, wherein the processor is further configured to
generate a plurality of expanded recorded voices by processing the first training voice data and the second training voice data;
generate a crosstalk predicted voice by superimposing a third expanded recorded voice onto a first expanded recorded voice, the first expanded recorded voice being one selected from among the plurality of expanded recorded voices, the third expanded being obtained by performing a delaying process and a volume conversion process on a second expanded recorded voice among the plurality of expanded recorded voices except for the first expanded recorded voice;
select a first crosstalk predicted voice, as the first training voice data, from among a plurality of the crosstalk predicted voices; and
generate the second training voice data by superimposing a plurality of second crosstalk predicted voices selected from among the plurality of crosstalk predicted voices except for the first crosstalk predicted voice.

9. The information processing apparatus according to claim 7, wherein the processor is further configured to
causes the voice processing model to convolute each of the first training voice data, the second training voice data, the first inference voice data, and the second inference voice data in a time direction.

10. The information processing apparatus according to claim 7, wherein the processor is further configured to
generate the clarified voice data by inputting the first inference voice data and the second inference voice data into the voice processing model.

11. The information processing apparatus according to claim 10, wherein:
the first training voice data is a first crosstalk predicted voice selected from a plurality of crosstalk predicted voices,
the second training voice data is obtained by superimposing two or more second crosstalk predicted voices selected from among the plurality of crosstalk predicted voices except for the first crosstalk predicted voice,
each of the plurality of crosstalk predicted voices are generated by superimposing a third expanded recorded voice onto a first expanded recorded voice, the first expanded recorded voice being selected from among a plurality of expanded recorded voices generated by processing the first training voice data and the second training voice data, the third expanded recorded voice being obtained by performing on a delaying process and a volume converting process on a second expanded recorded voice, the second expanded recorded voice being one among the plurality of expanded recorded voice and being different from the first expanded recorded voice.

12. The information processing apparatus according to claim 10, wherein the processor is further configured to:
causes the voice processing model to convolute each of the first training voice data, the second training voice data, the first inference voice data, and the second inference voice data in a time direction.

13. A computer-implemented method for generating a model comprising:
generating a voice processing model by executing machine learning using training data, the training data associating first training voice data obtained with a first microphone, second training voice data obtained with a second microphone different from the first microphone, and clarified training voice data with one another, the clarified training voice data being obtained by a clarifying process on voice contained at least one of the first training voice data and the second training voice data, the voice processing model generating clarified voice data in response to input of first inference voice data and second inference voice data.

14. The computer-implemented method according to claim 13, the method further comprising:
generating a plurality of expanded recorded voices by processing the first training voice data and the second training voice data;
generating a crosstalk predicted voice by superimposing a third expanded recorded voice onto a first expanded recorded voice, the first expanded recorded voice being one selected from among the plurality of expanded recorded voices, the third expanded being obtained by performing a delaying process and a volume conversion process on a second expanded recorded voice among the plurality of expanded recorded voices except for the first expanded recorded voice;
selecting a first crosstalk predicted voice, as the first training voice data, from among a plurality of the crosstalk predicted voices; and
generating the second training voice data by superimposing a plurality of second crosstalk predicted voices selected from among the plurality of crosstalk predicted voices except for the first crosstalk predicted voice.

15. The computer-implemented method according to claim 13, the method further comprising:
causing the voice processing model to convolute each of the first training voice data, the second training voice data, the first inference voice data, and the second inference voice data in a time direction.

16. The computer-implemented method according to claim 13, the method further comprising:
generating the clarified voice data by inputting the first inference voice data and the second inference voice data into the voice processing model.

17. The computer-implemented method according to claim 16, wherein
the first training voice data is a first crosstalk predicted voice selected from a plurality of crosstalk predicted voices,
the second training voice data is obtained by superimposing two or more second crosstalk predicted voices selected from among the plurality of crosstalk predicted voices except for the first crosstalk predicted voice,
each of the plurality of crosstalk predicted voices are generated by superimposing a third expanded recorded voice onto a first expanded recorded voice, the first expanded recorded voice being selected from among a plurality of expanded recorded voices generated by processing the first training voice data and the second training voice data, the third expanded recorded voice being obtained by performing on a delaying process and a volume converting process on a second expanded recorded voice, the second expanded recorded voice being one among the plurality of expanded recorded voice and being different from the first expanded recorded voice.

18. The computer-implemented method according to claim 16, the method further comprising:
causing the voice processing model to convolute each of the first training voice data, the second training voice data, the first inference voice data, and the second inference voice data in a time direction.
